(19) United States
(12) Patent Application Publication
(10) Pub. No.: US 2018/0001823 A1
(43) Pub. Date: Jan. 4, 2018

(54) SELECTIVELY REPOSITIONABLE SPOTTER MIRROR

(71) Applicant: Ficosa North America Corporation, Madison Heights, MI (US)

(72) Inventor: Vishal Bhaskar, Sterling Heights, MI (US)

(73) Assignee: Ficosa North America Corporation, Madison Heights, MI (US)

(21) Appl. No.: 15/636,968

(22) Filed: Jun. 29, 2017

Related U.S. Application Data
(60) Provisional application No. 62/357,204, filed on Jun. 30, 2016.

(51) Int. Cl. B60R 1/072; B60R 1/08

(52) U.S. Cl. CPC B60R 1/072; B60R 1/08

(57) ABSTRACT

A mirror assembly for a vehicle includes a housing configured to be coupled to the vehicle, a primary mirror assembly, and a secondary mirror assembly selectively repositionable independent of the primary mirror assembly. The primary mirror assembly includes a primary mirror configured to provide a reflection showing a primary field of view and a first base member coupled to the primary mirror and adjustably coupled to the housing. The secondary mirror assembly includes a secondary mirror configured to provide a reflection showing a secondary field of view and a second base member coupled to the secondary mirror. The second base member is pivotable about a point relative to the first base member such that the secondary mirror is adjustable relative to the primary mirror.

### CROSS-REFERENCE TO RELATED PATENT APPLICATIONS

This application claims the benefit of U.S. Provisional Patent Application No. 62/357,204, filed Jun. 30, 2016, which is incorporated herein by reference in its entirety.

### BACKGROUND

Embodiments of the present disclosure relate to a selectively repositionable spotter mirror for a mirror system and a method of making and using the same. All vehicles utilize external rear view mirrors to visualize an area along the side of or behind the vehicle and to fulfill mandatory legal field of view requirements. In some cases, the external mirrors include an additional spotter mirror or spotter glass that functions to help an operator of the vehicle visualize and see objects in a blind zone or blind spot area behind the operator. In vehicles equipped with the additional spotter glass, the external mirrors are adjustable, and any adjustment of the external mirror causes a corresponding adjustment in the spotter glass.

### SUMMARY

Systems, methods, and apparatuses for a mirror assembly are shown and described. In one embodiment, a mirror assembly for a vehicle includes a housing configured to be coupled to the vehicle, a primary mirror assembly, and a secondary mirror assembly selectively repositionable independent of the primary mirror assembly. The primary mirror assembly includes a primary mirror configured to provide a reflection showing a primary field of view and a first base member coupled to the primary mirror and adjustably coupled to the housing. The secondary mirror assembly includes a secondary mirror configured to provide a reflection showing a secondary field of view and a second base member coupled to the secondary mirror. The second base member is pivotable about a point relative to the first base member such that the secondary mirror is adjustable relative to the primary mirror.

In another embodiment, a mirror assembly for a vehicle includes a housing configured to be coupled to the vehicle a primary mirror assembly, a secondary mirror assembly selectively repositionable independent of the primary mirror assembly, and an actuator coupled to the primary mirror assembly. The primary mirror assembly includes a primary mirror configured to provide a reflection showing a primary field of view and a first base member coupled to the primary mirror and adjustably coupled to the housing. The secondary mirror assembly includes a secondary mirror configured to provide a reflection showing a secondary field of view and a second base member coupled to the secondary mirror. The second base member is pivotable about a point relative to the first base member such that the secondary mirror is adjustable relative to the primary mirror. The actuator is configured to selectively reposition the primary mirror assembly relative to the housing in response to a user input. The secondary mirror assembly is configured to be manually repositionable relative to the primary mirror assembly.

In yet another embodiment, a mirror assembly for a vehicle includes a housing configured to be coupled to the vehicle a primary mirror assembly, and a secondary mirror assembly selectively repositionable independent of the primary mirror assembly. The primary mirror assembly includes a primary mirror configured to provide a reflection showing a primary field of view and a first base member coupled to the primary mirror and adjustably coupled to the housing. The secondary mirror assembly includes a secondary mirror configured to provide a reflection showing a secondary field of view and a second base member coupled to the secondary mirror such that the secondary mirror assembly is repositioned relative to the housing whenever the primary mirror assembly is repositioned relative to the housing. The second base member is pivotable about a point relative to the first base member such that the secondary mirror is adjustable relative to the primary mirror.

These and other features, together with the organization and manner of operation thereof, may become apparent from the following detailed description when taken in conjunction with the accompanying drawings.

### BRIEF DESCRIPTION OF THE FIGURES

FIG. 1A is a front-perspective view of a side mirror assembly including a mirror system, according to an exemplary embodiment;

FIG. 1B is a top view of a vehicle including the side mirror assembly of FIG. 1A, according to an exemplary embodiment;

FIG. 2A is a front view of a mirror system, according to an exemplary embodiment;

FIG. 2B is a front-perspective view of the mirror system of FIG. 2A;

FIG. 2C is a rear-perspective view of the mirror system of FIG. 2A;

FIG. 2D is a rear view of the mirror system of FIG. 2A;

FIG. 2E is a side view of the mirror system of FIG. 2A;

FIG. 3 is an exploded-perspective view of the mirror system shown in FIG. 2A;

FIG. 4 is a side cross-sectional view of the mirror system shown in FIG. 2A about line 4-4;

FIG. 5 is a perspective, side cross-sectional view of the mirror system shown in FIG. 2A about line 4-4;

FIG. 6 is a top cross-sectional view of the mirror system shown in FIG. 2A about line 6-6;

FIG. 7 is a block diagram showing a control system, according to an exemplary embodiment;

FIG. 8 is a front perspective view of an adjustable secondary mirror assembly for a mirror system, according to an exemplary embodiment;

FIG. 9 is a rear perspective view of the adjustable secondary mirror assembly shown in FIG. 8;

FIG. 10 is a front view of a mirror system, according to another exemplary embodiment; and

FIG. 11 is a front view of a mirror system, according to another exemplary embodiment.

### DETAILED DESCRIPTION

Referring to the Figures generally, systems, methods, and apparatuses for a selectively repositionable spotter mirror are shown.

When driving a vehicle, it is desirable to be aware of the vehicle's surroundings. One area that causes particular difficulty is a blind spot of the vehicle. Blind spots are typically unique to every vehicle and operator combination. For example, for a single vehicle, different operators having different height percentiles (e.g., 25^{th} percentile vs. 75^{th} percentile of height) may have different blind spots. Further, vehicles often have seats which are adjustable. With adjustable seats, the blind spots that a particular operator experiences are likely to be unique to that specific operator. In order to assist operators in visualizing blind spots, some cars have side mirror assemblies which include a primary mirror and a spotter mirror that aids in blind spot visualization. The spotter mirrors are typically in the corner of the mirror assembly and offer a different reflected field of view to the operator than the primary mirror. Spotter mirrors are often integral with the mirror, and cannot be adjusted independent from the mirror. As a result, the operator is often left with deciding between adjusting the mirror assembly to utilize either the spotter mirror or the primary mirror. Often, when the operator decides to utilize the primary mirror, the spotter mirror cannot be properly utilized by the operator. This largely prohibits the spotter mirror from enabling the operator to visualize or to see objects in the blind spots.

According to the present disclosure, a mirror system includes a primary mirror assembly and a secondary mirror assembly. The primary mirror assembly may be moveable such that an operator can see an area along the side of a vehicle. The secondary mirror assembly may be moveable independent of the primary mirror assembly such that the operator can see a different area than can be seen in the primary mirror assembly. For example, the secondary mirror assembly can be used to focus on an area corresponding to a blind spot or an area behind the vehicle. In some embodiments, when the secondary mirror assembly is adjusted, the primary mirror assembly is not adjusted. Both the secondary mirror assembly and the primary mirror assembly may be electronically or manually selectively repositioned independent of each other and with respect to each other.

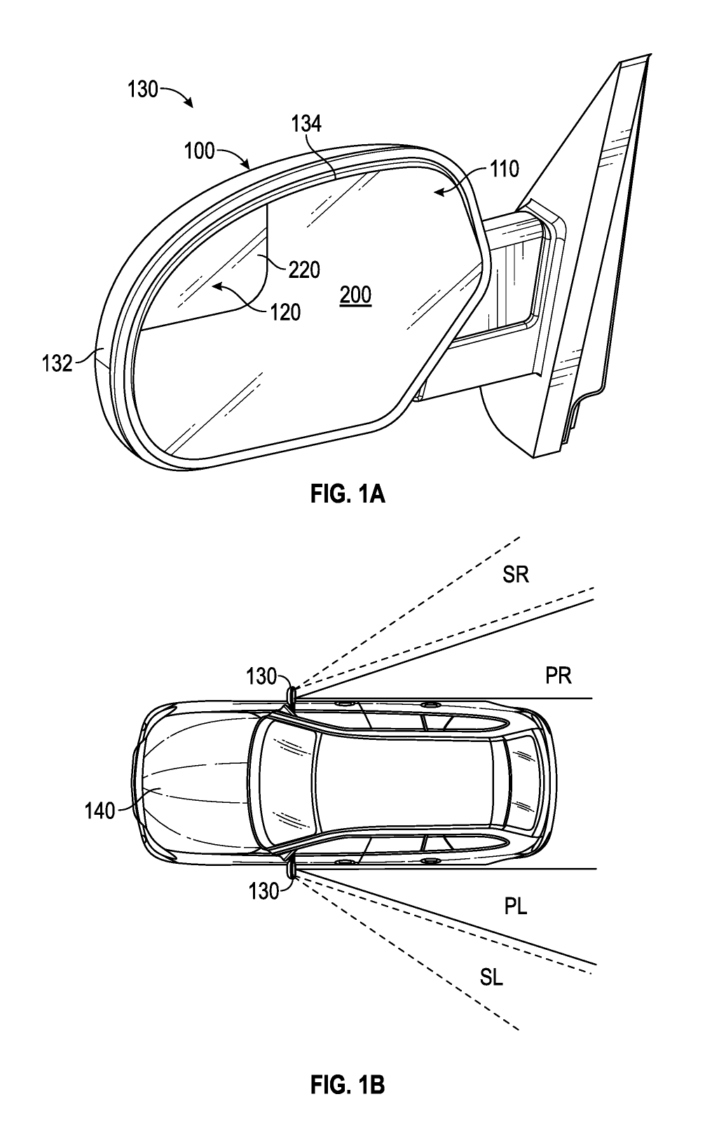

As shown in FIGS. 1A and 1B, a side mirror assembly 130 for use with a vehicle 140 includes a mirror system 100. Mirror system 100 includes a primary mirror assembly 110 and a secondary mirror assembly 120. Primary mirror assembly 110 provides a reflection showing a first field of view, and secondary mirror assembly 120 provides a reflection showing a second field of view. Secondary mirror assembly 120 is adjustable independently from primary mirror assembly 110 such that the field of view of each mirror assembly can be adjusted optimally for an operator or user of vehicle 140.

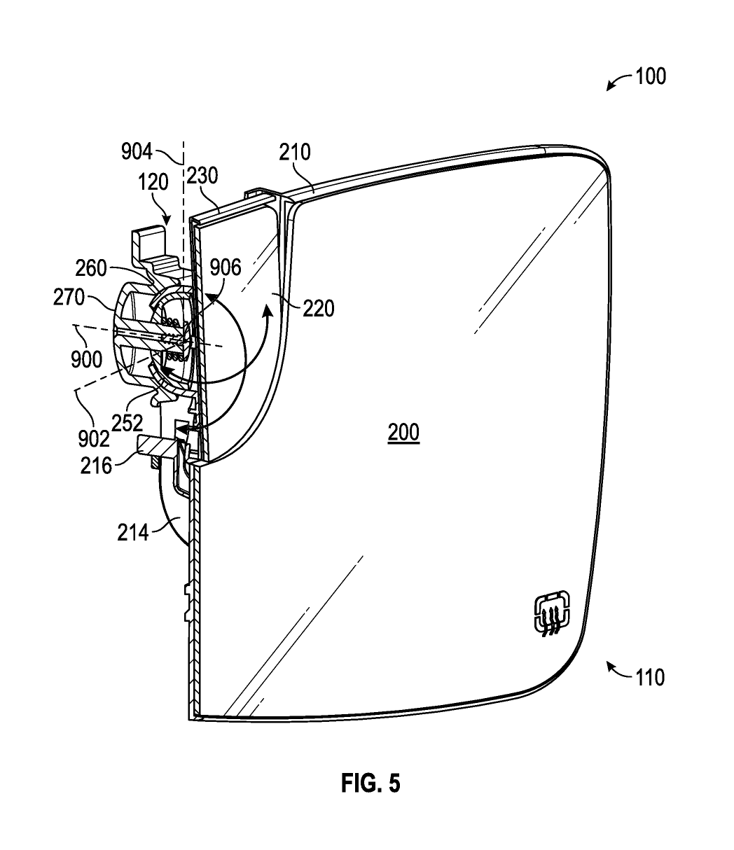

Referring to FIGS. 1A-6, a mirror, shown as mirror system 100, includes a first assembly or primary reflective surface assembly, shown as primary mirror assembly 110. Primary mirror assembly 110 is configured to reflect an image showing a field of view to an operator of a vehicle (e.g., truck, car, semi, emergency vehicle, bus, etc.). According to various embodiments, primary mirror assembly 110 is selectively repositionable relative to housing 132 and, accordingly, vehicle 140. In this way, the image or field of view reflected by primary mirror assembly 110 and seen by the operator may be adjusted. Mirror system 100 also includes a second assembly (e.g., comfort assembly, spotter assembly, secondary reflective surface assembly, etc.), shown as secondary mirror assembly 120. Secondary mirror assembly 120 is configured to reflect an image showing a field of view to the operator independent of primary mirror assembly 110. Secondary mirror assembly 120 is configured to be selectively repositioned relative to housing 132 independent of (i.e., without also repositioning) primary mirror assembly 110 such that the field of view seen by the operator may change. In operation, when primary mirror assembly 110 is repositioned, secondary mirror assembly 120 may also be repositioned. However, when secondary mirror assembly 120 is repositioned, primary mirror assembly 110 may not be repositioned. In this way, the operator may utilize primary mirror assembly 110 to visualize a first image and use secondary mirror assembly 120 to visualize a second image different from the first image. As a result, the operator may have an increased situational awareness in the vehicle compared to a conventional mirror with a stationary or built-in spotting portion that cannot be repositioned without repositioning the mirror.

In some embodiments, mirror system 100 is incorporated into a mirror assembly for a vehicle, shown as side mirror assembly 130. Referring to FIG. 1A, side mirror assembly 130 includes a housing 132 and the mirror system 100. Housing 132 defines an aperture 134, into which mirror system 100 is inserted. Primary mirror assembly 110 and secondary mirror assembly 120 each extend partway across aperture 134. In some embodiments, primary mirror assembly 110 and secondary mirror assembly 120 cooperate to extend across the entirety of aperture 134. Housing 132 is part of a side mirror assembly for a vehicle. Housing 132 may be coupled near the front of a vehicle on a door, a door frame, or a surrounding frame element of the vehicle. Housing 132 is configured to protect and support mirror system 100. In some embodiments, housing 132 is selectively repositionable relative to the remainder of the vehicle.

FIG. 1B shows an exemplary embodiment of a vehicle 140 utilizing the side mirror assembly 130. As shown in FIG. 1B, the primary direction of travel of vehicle 140 is oriented to the left. Vehicle 140 includes a side mirror assembly 130 on each lateral side, attached near the front end of vehicle 140. FIG. 1B shows the fields of view shown to a driver by primary mirror assembly 110 and secondary mirror assembly 120 for each side mirror assembly 130, with P or S indicating a primary or secondary field of view, and L or R indicating a left side or right side field of view, respectively. The fields of view of primary mirror assembly 110 and secondary mirror assembly 120 on the left side are shown as PL and SL, respectively. The fields of view of primary mirror assembly 110 and secondary mirror assembly 120 on the right side are shown as PR and SR, respectively. As shown in FIG. 1B, the secondary fields of view are arranged outboard of the primary fields of view, and the primary and secondary fields of view do not overlap. In other embodiments, a primary field of view is arranged outboard of the corresponding secondary field of view and/or a primary field of view overlaps a secondary field of view. The secondary fields of view may be configured to cover a blind spot that would otherwise be experienced by an operator. The relative width of each field of view may vary.

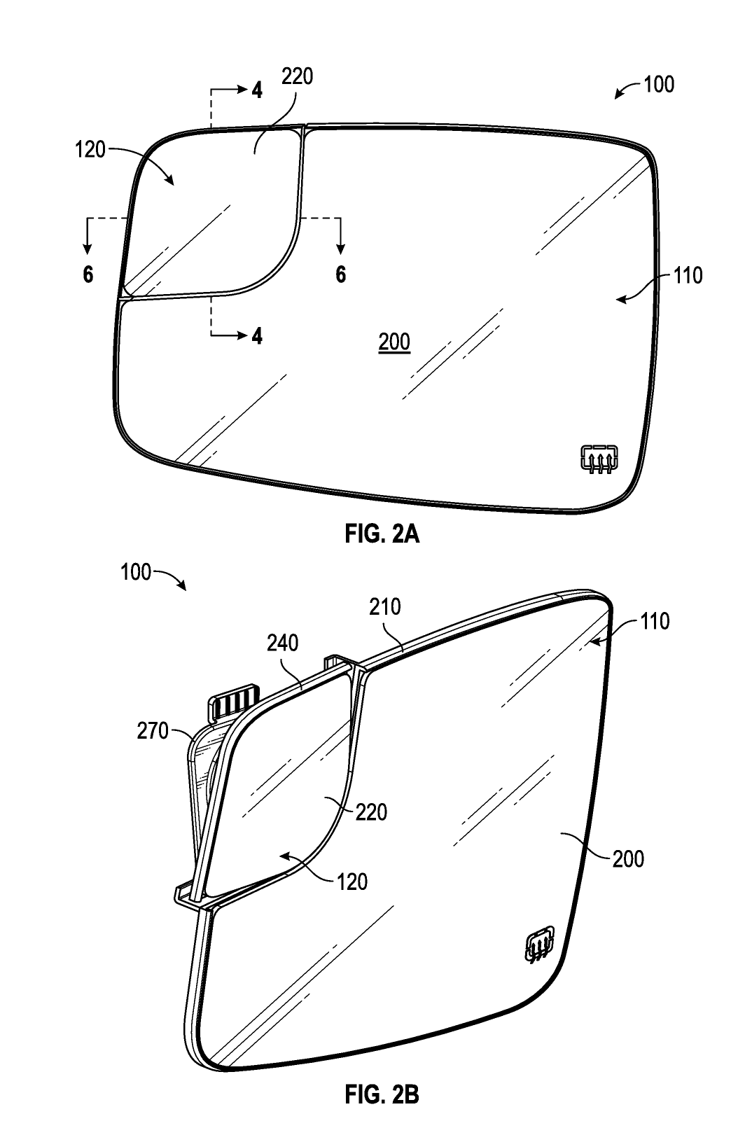

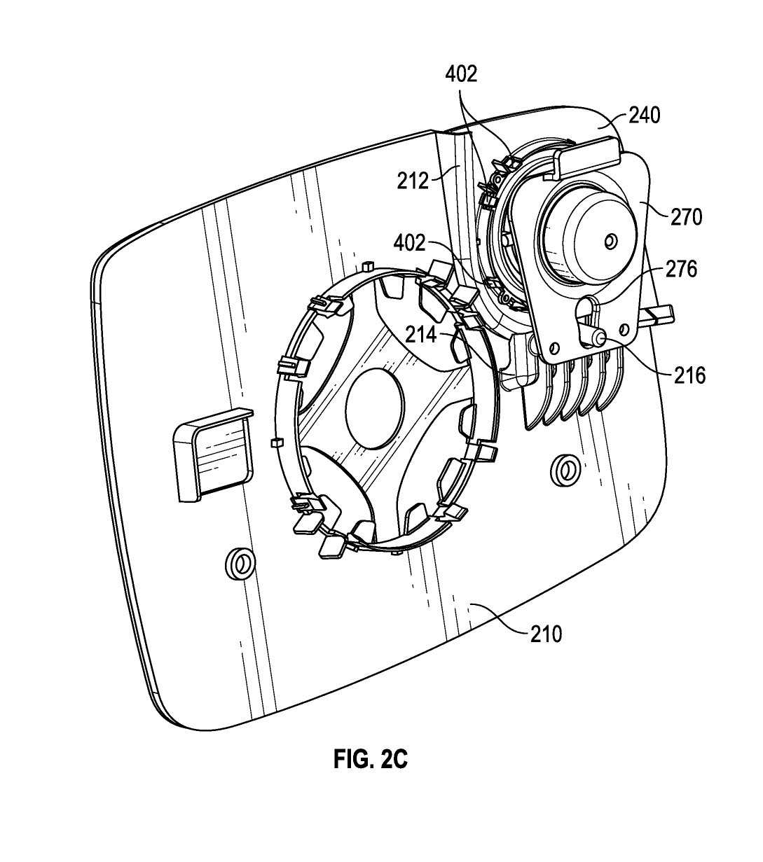

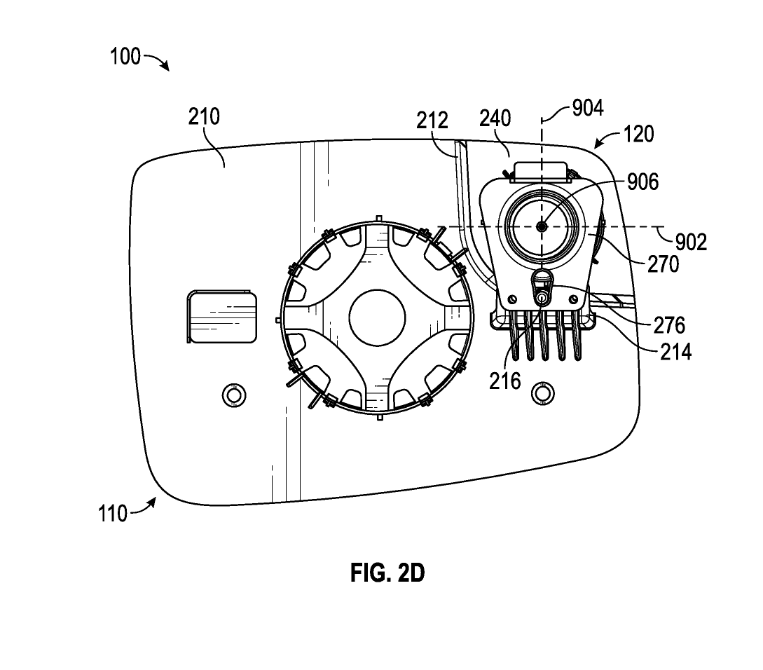

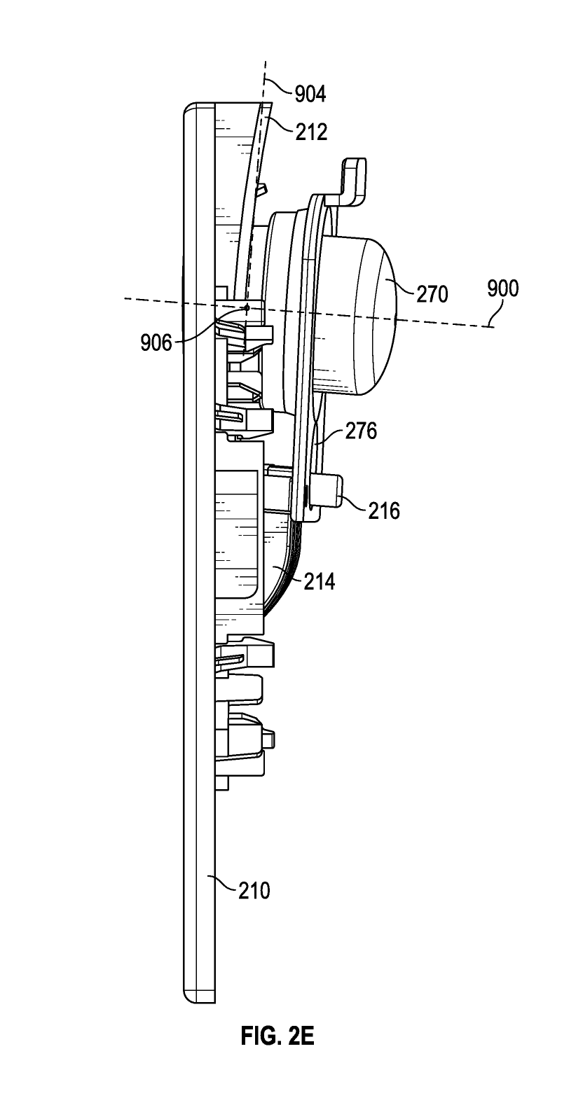

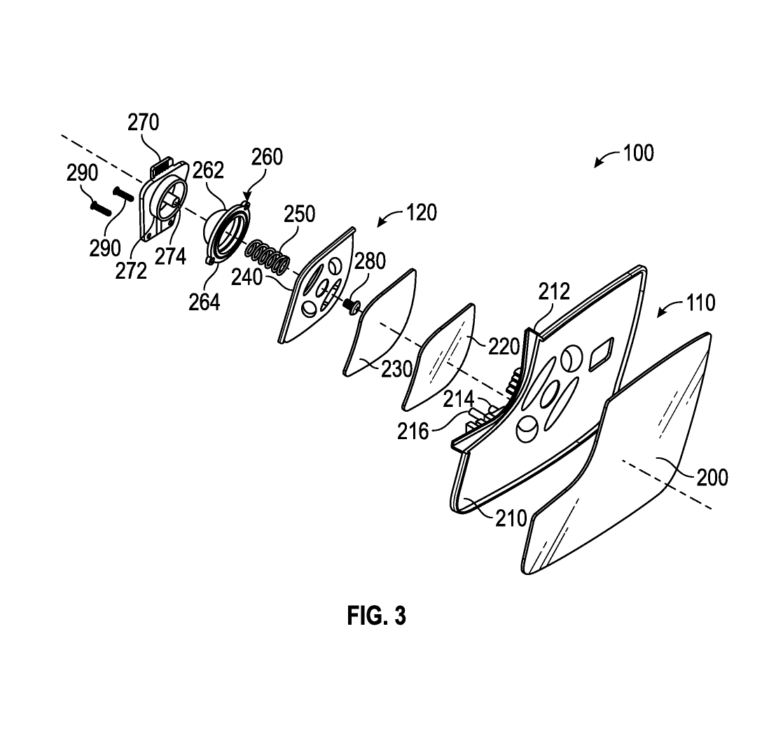

As shown in FIGS. 2A and 3, primary mirror assembly 110 includes an insert (e.g., glass, layer, reflective surface, etc.), shown as primary mirror or mirrored insert 200. Mirrored insert 200 is configured to provide a reflection of a field of view. Primary mirror assembly 110 also includes a base or base member (e.g., back plate, support, etc.), shown as mirror base member 210. Mirror base member 210 is configured to receive mirrored insert 200 and to couple mirror system 100 to housing 132. In some embodiments, mirror base member 210 includes a channel (e.g., flange, lip, rim, etc.), shown as receiving channel 212. Receiving channel 212 is sized to receive at least a portion of secondary mirror assembly 120. Mirror base member 210 also includes a flange, shown as flange 214, and a post, shown as alignment post 216, extending from flange 214. Flange 214 and alignment post 216 are configured to couple to secondary mirror assembly 120.

As shown in FIGS. 2A and 3, secondary mirror assembly 120 includes a first insert (e.g., glass, layer, reflective surface, etc.), shown as secondary mirror or mirrored insert 220. Like mirrored insert 200, mirrored insert 220 is configured to provide a reflection of a field of view. Secondary mirror assembly 120 also includes a second insert, shown as support insert 230. Support insert 230 is configured to provide structural support to mirrored insert 220. Secondary mirror assembly 120 also includes a base or base member (e.g., support, etc.), shown as spotter base member 240. Spotter base member 240 is configured to receive support insert 230, thereby also receiving mirrored insert 220.

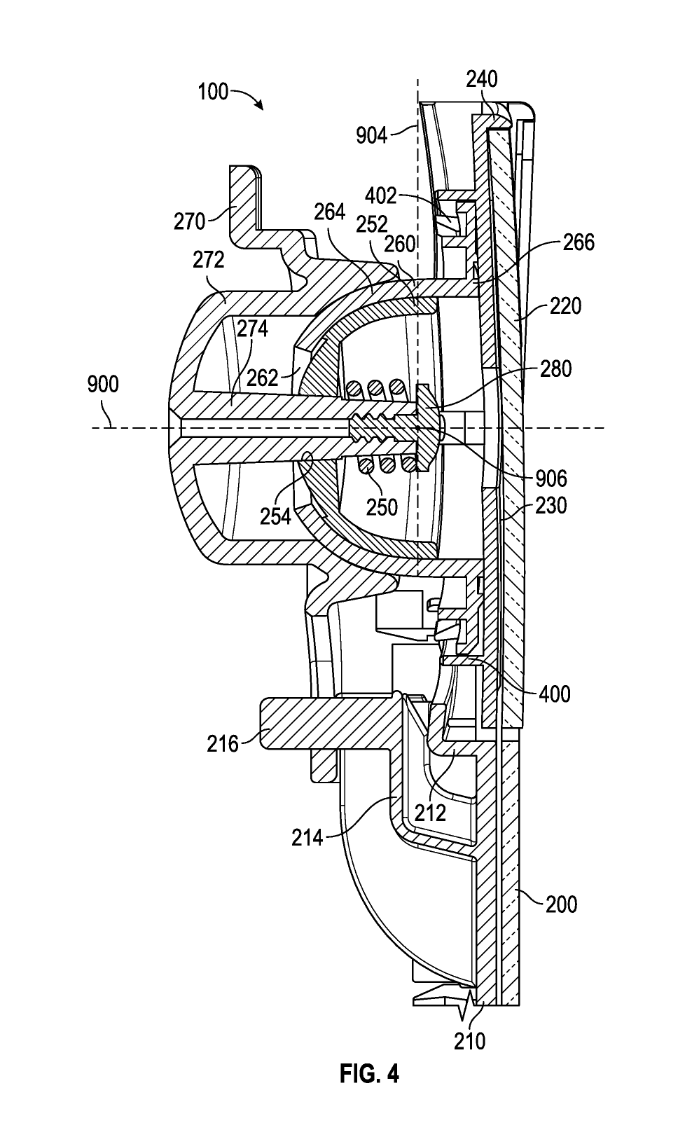

Referring to FIGS. 3 and 4, secondary mirror assembly 120 also includes a spring (e.g., biasing element, etc.), shown as spring 250, an adaptor, shown as adaptor 252, a coupler member, shown as coupler 260, and a frame member, shown as frame 270. Adaptor 252 defines an aperture, shown as adaptor aperture 254, and coupler 260 defines an aperture, shown as coupler aperture 262. Frame 270 includes a main body 272 and a projection, shown as frame shaft 274, extending away from main body 272. According to various embodiments, frame shaft 274 is internally threaded to receive a fastener (e.g., screw, bolt, etc.), shown as fastener 280. Coupler 260 has a first side, shown as ball side 264, and a second side opposite the first side, shown as flange side 266. Frame shaft 274 passes through coupler aperture 262 and adaptor aperture 254 such that ball side 264 of coupler 260 extends between frame 270 and adaptor 252. An interior surface and an exterior surface of ball side 264 are both curved. In some embodiments, the interior surface and/or the exterior surface of ball side 264 have a spherical curvature. In some such embodiments, the interior surface and the exterior surface of ball side 264 share the same center of curvature. A surface of frame 270 contacting the exterior surface of ball side 264 has a similar or corresponding curvature to the exterior surface of ball side 264. A surface of adaptor 252 contacting the interior surface of ball side 264 has a similar or corresponding curvature to the interior surface of ball side 264. Spring 250 extends between fastener 280 and adaptor 252, applying a biasing force to move adaptor 252 away from fastener 280 and toward frame 270.

As shown in FIGS. 2D, 2E, 4, 5, and 6 a number of axes are defined with respect to frame 270. A depth axis 900 is defined extending parallel to frame shaft 274 and through the center of frame shaft 274. A lateral axis 902 extends perpendicular to the depth axis 900. A vertical axis 904 extends perpendicular to both lateral axis 902 and depth axis 900. Due to the curvature of the mating surfaces of frame 270, coupler 260, and adaptor 252, coupler 260 is rotatable about a point, shown as center of rotation 906, through which depth axis 900, lateral axis 902, and vertical axis 904 extend. When pivoting, coupler 260 slides past frame 270 and adaptor 252. In embodiments where the mating surfaces of frame 270, coupler 260, and adaptor 252 have a spherical curvature, the coupler 260 is pivotable about any axis perpendicular to axis 900. In other embodiments, the mating surfaces of frame 270, coupler 260, and adaptor 252 have different curvatures such that the coupler 260 rotates about only certain axes perpendicular to axis 900. By way of example, the mating surfaces of frame 270, coupler 260, and adaptor 252 may have a cylindrical curvature such that the coupler 260 rotates about only one axis.

Referring to FIG. 4, in some embodiments, adaptor aperture 254 is approximately the same size as frame shaft 274, preventing movement of adaptor 252 perpendicular to the frame shaft 274. Coupler aperture 262 is larger than frame shaft 274, facilitating a range of motion of coupler 260 without contacting frame shaft 274. The biasing force of spring 250 forces coupler 260 against adaptor 252 and frame 270, preventing translation of coupler 260 relative to frame 270. The biasing force of spring 250 increases frictional forces between the mating surfaces of frame 270, coupler 260, and adaptor 252, resisting rotational movement of coupler 260 until a threshold torque is applied to the coupler 260. The properties of spring 250 (e.g., spring constant, length, etc.) and the position of fastener 280 may be varied to adjust the threshold torque required to move coupler 260.

As shown in FIG. 4, flange side 266 is received in a channel (e.g., track, etc.), shown as channel 400, in spotter base member 240. Flange side 266 is coupled (e.g., using fasteners, adhesive, etc.) to spotter base member 240. As shown in FIG. 4, spotter base member 240 includes clips 402 that extend around flange side 266, holding coupler 260 in place. In other embodiments, spotter base member 240 and coupler 260 are integrally formed as a single piece. Frame 270 is configured to be coupled to flange 214 through the use of fasteners (e.g., screws, bolts, etc.), shown as fasteners 290. In other embodiments, frame 270 is otherwise coupled to mirror base member 210 or frame 270 and mirror base member 210 are integrally formed as a single piece. As shown in FIG. 2C, alignment post 216 is received by a corresponding aperture 276 in the frame 270. Coupler 260 is configured to move relative to frame 270, thereby moving spotter base member 240 and correspondingly moving mirrored insert 220. Because frame 270 is coupled to flange 214, mirrored insert 220 may be moved or repositioned independently of mirrored insert 200. In an exemplary operation, the operator first sets the position of mirrored insert 200 (e.g., through electronic controls, through manual articulation, etc.). Next, the operator sets the position of mirrored insert 220 (e.g., through electronic controls, through manual articulation, etc.). The independent mobility of mirrored insert 220 allows an operator to fine tune the position of mirrored insert 220 to display a desired view rearward of the vehicle such as a blind spot without disturbing the position of mirrored insert 200.

In some embodiments, a similar arrangement to the frame 270, coupler 260, and adaptor 252 arrangement discussed herein is used to couple primary mirror assembly 110 to housing 132.

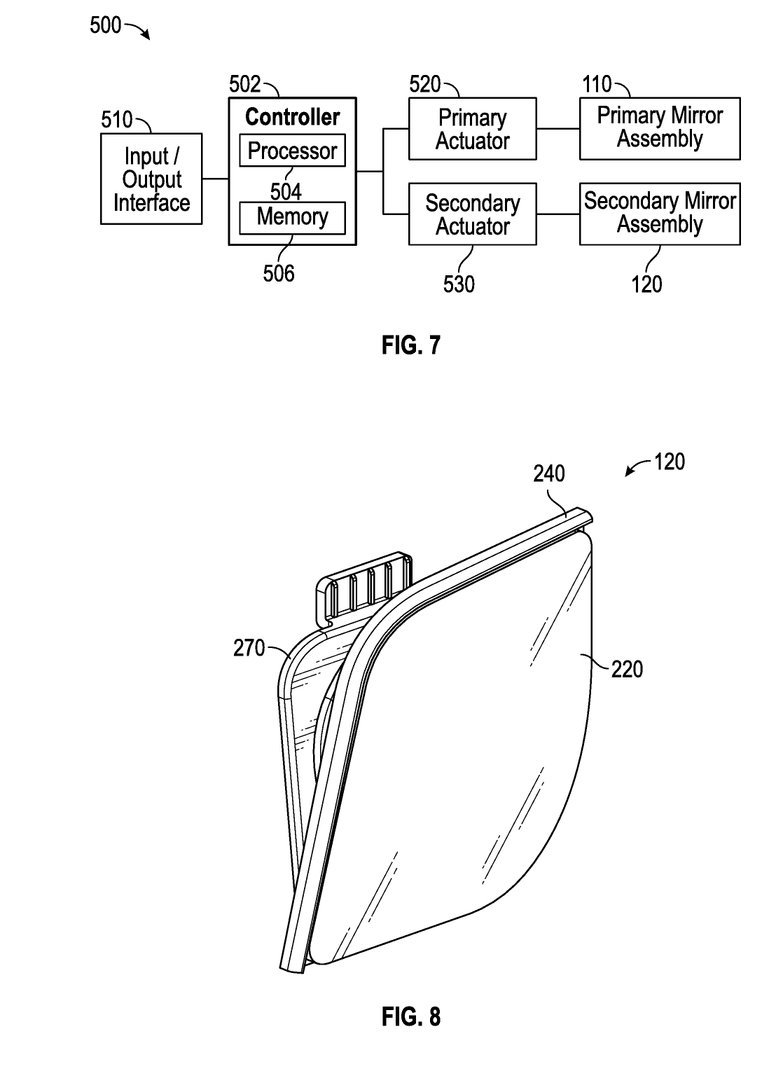

Referring to FIG. 7, a control system 500 is shown. In some embodiments, control system 500 is incorporated into mirror system 100 or vehicle 140 to electronically control the actuation of (i.e., electrically reposition) primary mirror assembly 110 or secondary mirror assembly 120. Control system 500 includes a controller 502 that includes a processor 504 and a memory 506. Processor 504 is configured to receive information and issue commands. Memory 506 is configured to store and distribute information. Controller 502 is configured to receive inputs or commands from an operator and/or output information to an operator through an input/output interface 510. Input/output interface 510 may include one or more of switches, buttons, joysticks, sliders, displays, touchscreens, or other interface devices. Control system 500 may include an actuator, shown as primary actuator 520, and/or another actuator, shown as secondary actuator 530. Primary actuator 520 is configured to receive a signal from controller 502 and, in response, adjust the orientation of mirrored insert 200 relative to housing 132 (i.e., reposition primary mirror assembly 110). Secondary actuator 530 is configured to receive a signal from controller 502 and, in response, adjust the orientation of mirrored insert 220 relative to mirrored insert 220 (i.e., reposition secondary mirror assembly 120). Primary actuator 520 and secondary actuator 530 may be coupled to any component of primary mirror assembly 110, secondary mirror assembly 120, housing 132, or vehicle 140.

In other embodiments, one or both of primary actuator 520 and secondary actuator 530 are omitted, and primary mirror assembly 110 and/or secondary mirror assembly 120 are instead repositioned manually (e.g., by an operator applying a force or torque directly on primary mirror assembly 110 or secondary mirror assembly 120). Accordingly, primary mirror assembly 110 and secondary mirror assembly 120 may each be either manually repositioned or repositioned using an actuator.

Secondary mirror assembly 120 may be configured to maintain an orientation relative to primary mirror assembly 110 until secondary mirror assembly 120 experiences a threshold torque, either applied directly or created by a force offset from center of rotation 906. Friction between frame 270, coupler 260, and adaptor 252 prevents secondary mirror assembly 120 from moving until the threshold torque overcomes the friction. The threshold torque may be applied by an operator, by an actuator, or by another source. A similar mechanism may couple primary mirror assembly 110 to housing 132 such that primary mirror assembly 110 is configured to maintain an orientation relative to housing 132 until primary mirror assembly 110 experiences a threshold torque.

Processor 504 may be implemented as a specific purpose processor, an application specific integrated circuit (ASIC), one or more field programmable gate arrays (FPGAs), a group of processing components, or other suitable electronic processing components. Memory 506 is one or more devices (e.g., RAM, ROM, flash memory, hard disk storage) for storing data and computer code for completing and facilitating the various user or client processes, layers, and modules described in the present disclosure. Memory 506 may be or include volatile memory or non-volatile memory and may include database components, object code components, script components, or any other type of information structure for supporting the various activities and information structures of the inventive concepts disclosed herein. Memory 506 is communicably connected to processor 504 and includes computer code or instruction modules for executing one or more processes described herein.

In some embodiments, mirror system 100 includes an actuator (e.g., primary actuator 520 or secondary actuator 530) configured to selectively reposition mirrored insert 220. For example, secondary actuator 530 may include a series of linear actuators extending between frame 270 and coupler 260 or spotter base member 240. Extension or retraction of the linear actuators rotates coupler 260 relative to frame 270. By way of another example, primary actuator 520 may include a series of linear actuators extending between housing 132 and mirror base member 210. Extension or retraction of the linear actuators rotates primary mirror assembly 110 relative to housing 132 about a point. By way of yet another example, the secondary actuator 530 includes a gear mechanism coupled to the frame 270 and configured to interface with spotter base member 240 to rotate mirrored insert 220. In other embodiments, one or both of the actuators are omitted and the mirror assemblies are articulated or repositioned manually by an occupant of the vehicle (e.g., the operator, etc.). In these embodiments, friction between the various components facilitates selective manual repositioning of the mirrored inserts relative to housing 132. In either case, mirrored insert 200 and/or mirrored insert 220 may be set to a variety of different orientations. Due to the coupling between frame 270, coupler 260, and adaptor 252, mirrored insert 220 is adjustable to an infinite number of orientations. For each pair of orientations of mirrored insert 220, mirrored insert 220 can be moved to another orientation between the pair, resulting in the infinite number of orientations. Accordingly, secondary mirror assembly 120 is reconfigurable into an infinite number of orientations relative to primary mirror assembly 110, as opposed to having only a finite number of relative orientations.

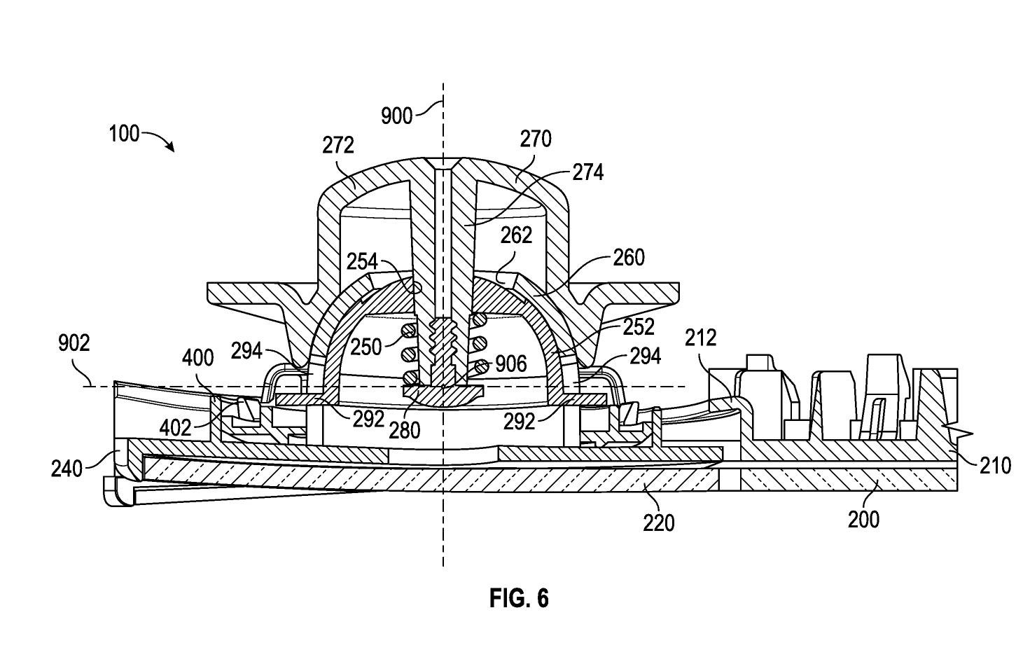

In some embodiments, the movement of secondary mirror assembly 120 is intentionally restricted. In these embodiments, the movement of secondary mirror assembly 120 may be restricted structurally through frame 270, coupler 260, adaptor 252, or another component of mirror system 100. By way of example, coupler 260 may be restricted from rotating about axis 900. As shown in FIG. 6, adaptor 252 includes a pair of studs 292 extending therefrom along the axis 902. Studs 292 extend into corresponding slots 294 in coupler 260, preventing relative rotation between adaptor 252 and coupler 260 when studs 292 contact coupler 260. In some embodiments, adaptor 252 is rotationally fixed relative to frame 270 (e.g., through frictional or interference engagement between adaptor 252 and frame shaft 274) such that rotation of coupler 260 relative to frame 270 is prevented. Due to the placement of studs 292 and slot 294, however, coupler 260 can still rotate about axis 902 and axis 904.

According to various embodiments, secondary mirror assembly 120 is located on an outboard (e.g., opposite vehicle 140) side of mirror system 100. In other embodiments, secondary mirror assembly 120 is located on an inboard (e.g., proximate vehicle 140) side of mirror system 100. In some embodiments, secondary mirror assembly 120 is located on a top side of mirror system 100. In other embodiments, secondary mirror assembly 120 is located on a bottom side of mirror system 100. It is understood that secondary mirror assembly 120 can be located at any location and be of any size compared to mirror system 100. The operator of vehicle 140 may adjust primary mirror assembly 110 and/or secondary mirror assembly 120 depending on a seating location in vehicle 140. For example, if the operator moves the operator's seat of vehicle 140, the operator may correspondingly adjust secondary mirror assembly 120. According to various embodiments, input/output interface 510 includes a first set of electronic controls (e.g., levers, knobs, etc.) configured to control primary mirror assembly 110 and a second set of electronic controls configured to control secondary mirror assembly 120. The memory 506 may be configured to store a preset position of primary mirror assembly 110 and/or secondary mirror assembly 120, in some cases for a particular operator. The presets may be selectable by an operator in vehicle 140. When the operator selects a preset, controller 502 may command primary actuator 520 and/or secondary actuator 530 to move the corresponding mirror assembly to a position stored in memory 506. In this way, vehicle 140 can easily adjust a position of the mirror assemblies for different operators in a short amount of time.

In various applications, mirrored insert 200 and mirrored insert 220 are constructed from mirrored glass. In other applications, mirrored insert 200 and mirrored insert 220 are constructed from mirrored plastic or polymer. In still other embodiments, mirrored insert 200 and mirrored insert 220 are constructed from a similar mirrored material. According to various embodiments, mirrored insert 220 has a convex shape. In some embodiments, mirrored insert 200 has a flat or planar shape. Mirrored insert 220 may be coupled to support insert 230 through the use of an adhesive, such as glue or double-sided tape. In an alternative embodiment, mirrored insert 220 is encapsulated in support insert 230 (e.g., through a molding process, etc.).

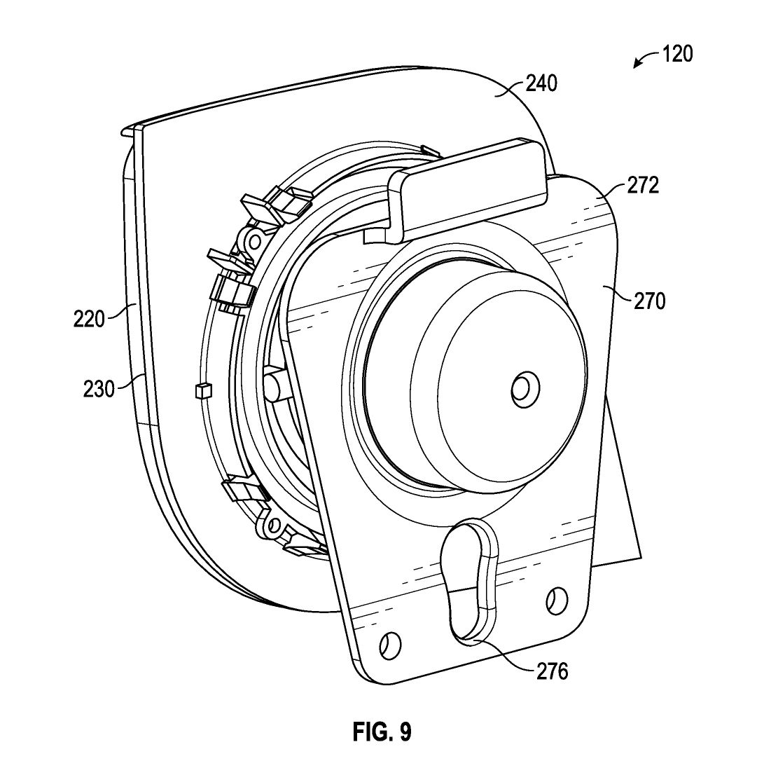

FIGS. 8-9 illustrate secondary mirror assembly 120. Various components of secondary mirror assembly 120 may be changed, altered, and replaced such that mirror system 100 is tailored for a target application. For example, the shape and size of spotter base member 240, support insert 230, and mirrored insert 220 may be altered to provide additional functionality to mirror system 100.

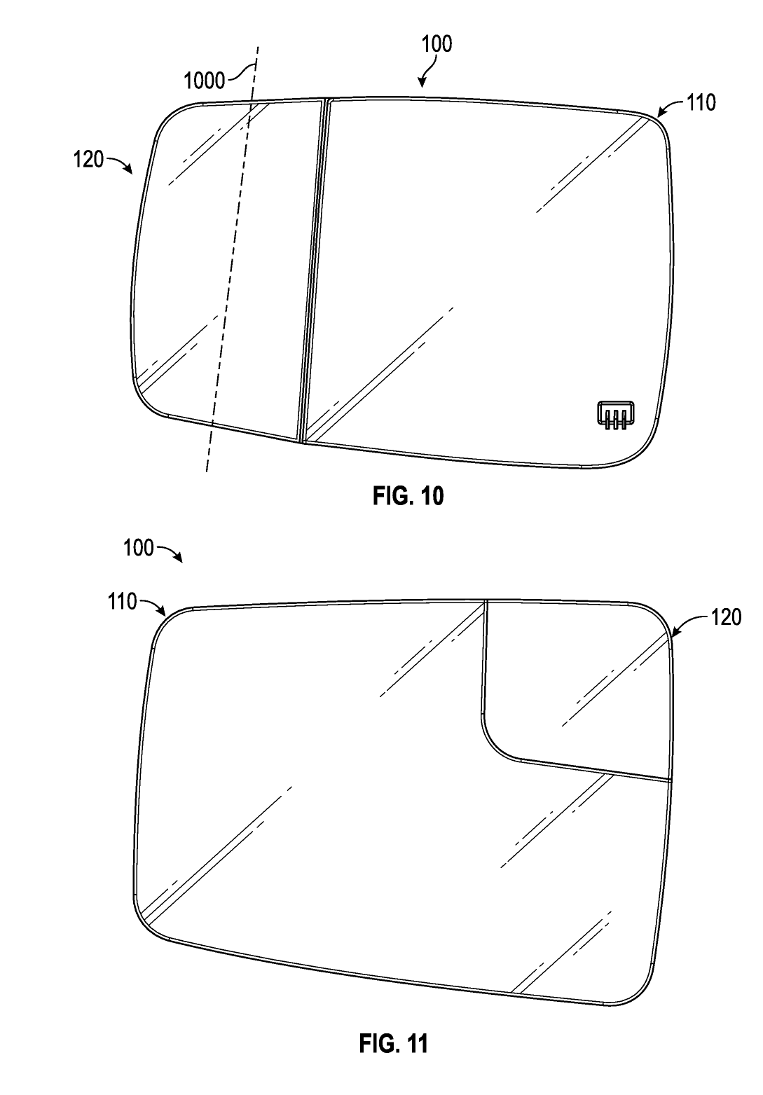

FIGS. 10-11 illustrate alternative embodiments of mirror system 100. As shown in FIG. 10, secondary mirror assembly 120 is configured to be much larger than as shown in FIG. 2A. In FIG. 10, secondary mirror assembly 120 is configured to rotate about an axis, shown as axis of rotation 1000. By rotating about axis of rotation 1000, secondary mirror assembly 120 is simplified and provides a larger reflected image to the operator than secondary mirror assembly 120 in FIG. 2A. As shown in FIG. 11, secondary mirror assembly 120 is located on an inboard (e.g., proximate vehicle 140) side of mirror system 100. In this manner, secondary mirror assembly 120 may provide additional functionality to mirror system 100 by facilitating visualization of fields of view that are outboard of vehicle 140. The particular configuration shown in FIG. 11 may be of particular use in applications where views of outboard objects are limited, such as military vehicle or emergency vehicle applications.

According to various embodiments, secondary mirror assembly 120 is replaceable and serviceable. For example, in some embodiments, secondary mirror assembly 120 is removed by removing fasteners 290 and removing coupler 260 from spotter base member 240. Similarly, individual components of secondary mirror assembly 120, such as frame 270, may be serviced and replaced. For example, once secondary mirror assembly 120 is removed from mirror system 100, frame 270 may be removed from secondary mirror assembly by removing support insert 230 and mirrored insert 220, and then removing fastener 280. In this way, various components of secondary mirror assembly 120 can be replaced and serviced.

In some embodiments, secondary mirror assembly 120 does not include support insert 230 and spotter base member 240 receives mirrored insert 220 directly. In one embodiment, support insert 230 has a convex shape and mirrored insert 220 has a matching convex shape. In other embodiments, mirrored insert 220 is flexible and support insert has a convex shape such that mirrored insert 220 forms around support insert 230 when installed in secondary mirror assembly 120.

According to various embodiments, any of mirror system 100, primary mirror assembly 110, and secondary mirror assembly 120 may be heated (e.g., in a de-frost mode) and may contain lights (e.g., driving lights, directional lights, proximity awareness lights, security lights, alarm lights, etc.). By way of example, support insert 230 may include an electrical heating element configured to emit thermal energy into secondary mirror assembly 120. The primary mirror assembly 110 and secondary mirror assembly 120 may both or either be magnified or tinted depending on an application of mirror system 100. Further, the shape, size, and configuration of any of mirror system 100, primary mirror assembly 110, and secondary mirror assembly 120 may be altered depending on an application of mirror system 100. Similarly, any of mirror system 100, primary mirror assembly 110, and secondary mirror assembly 120 may be set to positions automatically by control system 500. Memory 506 may store presets or instructions for particular orientations and configurations of primary mirror assembly 110 and secondary mirror assembly 120.

Mirror system 100 may be utilized by a variety of vehicles. For example, mirror system 100 may be utilized by trucks, delivery trucks, delivery vans, refuse trucks, construction vehicles, agricultural vehicles, emergency vehicles, military vehicles, cars, race cars, competition vehicles, motorcycles, mopeds, scooters, bicycles, aircraft, and other vehicles.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

The present disclosure is not limited to the particular methodology, protocols, and expression of design elements, etc., described herein and as such may vary. The terminology used herein is for the purpose of describing particular embodiments only, and is not intended to limit the scope of the present disclosure.

As used herein, the singular forms include the plural reference and vice versa unless the context clearly indicates otherwise. The term “or” is inclusive unless modified, for example, by “either.” For brevity and clarity, a particular quantity of an item may be described or shown while the actual quantity of the item may differ. Other than in the operating examples, or where otherwise indicated, all numbers expressing measurements used herein should be understood as modified in all instances by the term “about,” allowing for ranges accepted in the art.

Unless defined otherwise, all technical terms used herein have the same meaning as those commonly understood to one of ordinary skill in the art to which this invention pertains. Although any known methods, devices, and materials may be used in the practice or testing of the inventive concepts, the methods, devices, and materials in this regard are described herein.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in deposit to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure.

What is claimed is:

1. A mirror assembly for a vehicle, comprising:
a housing configured to be coupled to the vehicle;
a primary mirror assembly, including:
a primary mirror configured to provide a reflection showing a primary field of view; and
a first base member coupled to the primary mirror and adjustably coupled to the housing; and
a secondary mirror assembly selectively repositionable independent of the primary mirror assembly, the secondary mirror assembly including:
a secondary mirror configured to provide a reflection showing a secondary field of view; and
a second base member coupled to the secondary mirror and pivotable about a point relative to the first base member such that the secondary mirror is adjustable relative to the primary mirror.

2. The mirror assembly of claim 1, wherein the secondary mirror assembly is configured to be manually repositionable relative to the primary mirror assembly.

3. The mirror assembly of claim 1, further comprising a frame member coupled to the first base member and a coupler member coupled to the second base member, wherein the coupler member is adjustably coupled to the frame member.

4. The mirror assembly of claim 3, wherein the frame member is removably coupled to the first base member such that the secondary mirror assembly is removable and replaceable.

5. The mirror assembly of claim 1, wherein the secondary mirror assembly is infinitely positionable within a predetermined range of motion relative to the primary mirror assembly.

6. The mirror assembly of claim 1, further comprising an actuator configured to at least one of:
selectively reposition the secondary mirror assembly relative to the primary mirror assembly in response to a first user input; and
selectively reposition the primary mirror assembly relative to the housing in response to a second user input.

7. The mirror assembly of claim 1, wherein the housing defines an aperture, wherein the primary mirror and the secondary mirror each extend partially across the aperture and collectively substantially cover the aperture.

8. The mirror assembly of claim 1, further comprising a heating element configured to emit thermal energy into at least one of the primary mirror and the secondary mirror.

9. A mirror assembly for a vehicle, comprising:
a housing configured to be coupled to the vehicle;
a primary mirror assembly, including:
a primary mirror configured to provide a reflection showing a primary field of view; and
a first base member coupled to the primary mirror and adjustably coupled to the housing;
a secondary mirror assembly selectively repositionable independent of the primary mirror assembly, the secondary mirror assembly including:
a secondary mirror configured to provide a reflection showing a secondary field of view; and
a second base member coupled to the secondary mirror and pivotable about a point relative to the first base member such that the secondary mirror is adjustable relative to the primary mirror; and
an actuator coupled to the primary mirror assembly and configured to selectively reposition the primary mirror assembly relative to the housing in response to a user input;
wherein the secondary mirror assembly is configured to be manually or electrically repositionable relative to the primary mirror assembly.

10. The mirror assembly of claim 9, further comprising a frame member coupled to the first base member and a coupler member coupled to the second base member, wherein the coupler member is adjustably coupled to the frame member.

11. The mirror assembly of claim 10, wherein the frame member is removably coupled to the first base member such that the secondary mirror assembly is removable and replaceable.

12. The mirror assembly of claim 9, wherein the secondary mirror assembly is infinitely positionable within a predetermined range of motion relative to the primary mirror assembly.

13. The mirror assembly of claim 9, further comprising a heating element configured to emit thermal energy into at least one of the primary mirror and the secondary mirror.

14. The mirror assembly of claim 13, wherein the heating element extends between the secondary mirror and the second base member, and wherein the heating element is configured to emit thermal energy into the secondary mirror.

15. A mirror assembly for a vehicle, comprising:
a housing configured to be coupled to the vehicle;
a primary mirror assembly, including:
a primary mirror configured to provide a reflection showing a primary field of view; and
a first base member coupled to the primary mirror and adjustably coupled to the housing; and
a secondary mirror assembly selectively repositionable independent of the primary mirror assembly, the secondary mirror assembly including:
a secondary mirror configured to provide a reflection showing a secondary field of view; and
a second base member coupled to the secondary mirror such that the secondary mirror assembly is repositioned relative to the housing when the primary mirror assembly is repositioned relative to the housing, wherein the second base member is pivotable about a point relative to the first base member such that the secondary mirror is adjustable relative to the primary mirror.

16. The mirror assembly of claim 15, wherein the secondary mirror assembly is configured to be manually repositionable relative to the primary mirror assembly.

17. The mirror assembly of claim 15, further comprising a frame member coupled to the first base member and a coupler member coupled to the second base member, wherein the coupler member is adjustably coupled to the frame member.

18. The mirror assembly of claim 17, wherein the frame member is removably coupled to the first base member such that the secondary mirror assembly is removable and replaceable.

19. The mirror assembly of claim 15, wherein the secondary mirror assembly is infinitely positionable within a predetermined range of motion relative to the primary mirror assembly.

20. The mirror assembly of claim 15, further comprising an actuator configured to at least one of:
selectively reposition the secondary mirror assembly relative to the primary mirror assembly in response to a first user input; and
selectively reposition the primary mirror assembly relative to the housing in response to a second user input.
